(19) United States
(12) Patent Application Publication
(10) Pub. No.: US 2024/0098487 A1
(43) Pub. Date: Mar. 21, 2024

(54) METHOD AND APPARATUS FOR SENDING SUBSCRIBER IDENTIFIERS

(71) Applicant: HEFEI TUGE TECHNOLOGY CO., LTD, Hefei (CN)

(72) Inventors: LINLIN ZHOU, HEFEI (CN); TIANMING LU, HEFEI (CN); HAO ZHOU, HEFEI (CN); KAIHANG WANG, HEFEI (CN)

(73) Assignee: HEFEI TUGE TECHNOLOGY CO., LTD., HEFEI (CN)

(21) Appl. No.: 18/039,851

(22) PCT Filed: Oct. 14, 2021
(86) PCT No.: PCT/CN2021/123683

§ 371 Date: Jun. 1, 2023

(30) Foreign Application Priority Data
Dec. 18, 2020 (CN) 202011508792.5

(51) Int. Cl. H04W 12/02; H04W 8/20; H04W 12/72

(52) U.S. Cl. CPC H04W 12/02; H04W 8/205; H04W 12/72

(57) ABSTRACT

A method and apparatus for sending subscriber identifiers are disclosed. The method includes: receiving information of a USIM card from a UICC in a cloud card pool over a first communication connection; receiving an identity request from a 5G SA network, wherein the identity request is for requesting acquiring a SUCI; acquiring the SUCI based on the identity request and the information of the USIM card; and sending the SUCI to the 5G SA network, wherein the SUCI is for establishing a second communication connection. The SUCI may be generated at the ME or at the UICC. The first communication connection may be a roaming communication connection and the second communication connection may be a non-roaming communication connection.

### CROSS-REFERENCE TO RELATED APPLICATIONS

This is a continuation of U.S. National Stage of Application No. PCT/CN2021/123683, entitled “METHOD AND APPARATUS FOR SENDING SUBSCRIBER IDENTIFIERS,” filed on Oct. 14, 2021; and assigned International Publication No. WO/2022/116695; published on Jun. 9, 2022, which claims priority to Chinese Patent Application No. CN 202011508792.5 of the same title; filed Dec. 18, 2020, the contents of each application in their entirety are herein incorporated by reference.

### TECHNICAL FIELD

The present disclosure relates to the field of communications, and in particular, relates to methods and apparatuses for sending subscriber identifiers.

### BACKGROUND

Based on cloud communications, communication connections can be established without physical subscriber identity module (SIM) cards. A terminal device may establish a first communication connection using a physical or virtual SIM card, acquire information of a cloud SIM card from a cloud end over the communication connection, and establish a second communication connection based on the information of the cloud SIM card. In this way, it is unnecessary to configure two card slots in the terminal device, and hence costs of the terminal device are lowered.

When the second communication connection is a communication connection of a standalone (SA) network in a fifth generation (5G) mobile communication system, how to establish the second communication connection in cloud communication scenarios is the current problem to be solved.

### SUMMARY

Various embodiments of the present disclosure provide a method and apparatus for sending subscriber identifiers, which implement identity verification of an SA network in cloud communication scenarios, such that a second communication connection is established.

According to one aspect of the embodiments of the present disclosure, a method for sending subscriber identifiers is provided. The method includes: receiving, by a mobile equipment (ME), information of a universal subscriber identity module (USIM) card from a universal integrated circuit card (UICC) in a cloud card pool over a first communication connection; receiving, by the ME, an identity request from a 5G stand alone SA network, wherein the identity request is for requesting acquiring a subscriber concealed identifier (SUCI); acquiring, by the ME, the SUCI based on the identity request and the information of the USIM card, wherein the information of the USIM card indicates that the SUCI is generated by the ME or the UICC; and sending, by the ME, the SUCI to the 5G SA network, wherein the SUCI is for establishing a second communication connection.

The SUCI may be generated at the ME or at the UICC. In some embodiments, where the information of the USIM card indicates that the SUCI needs to be generated at the ME, the ME may generate the SUCI locally, which avoids a delay of acquiring the SUCI from the UICC. In this way, the second communication connection may be quickly established. In some embodiments, where the information of the USIM card indicates that the SUCI needs to be generated at the UICC, for example, where the information of the USIM card does not include a service no 124 or a service no 125, the ME may acquire the SUCI from the UICC, thereby ensuring successful establishment of the second communication connection.

According to another aspect of the embodiments of the present disclosure, an apparatus for sending subscriber identifiers is provided. The apparatus includes units for performing any of the methods according to the first aspect.

According to still another aspect of the embodiments of the present disclosure, a device for sending subscriber identifiers is provided. The device includes a processor and a memory. The memory is configured to store one or more computer programs. The processor, when loading and running the one or more computer programs, is caused to perform any of the methods according to the first aspect.

According to yet still another aspect of the embodiments of the present disclosure, a computer program product is provided. The computer program product includes computer program code. The computer program code, when loaded and run by the apparatus for sending subscriber identifiers, causes the apparatus to perform any of the methods according to the first aspect.

According to yet still another aspect of the embodiments of the present disclosure, a computer-readable storage medium is provided. The computer-readable storage medium stores program code. The program code includes instructions for performing the method according to the first aspect.

The method and apparatus for sending subscriber identifiers according to the present disclosure implement identity verification of an SA network in cloud communication scenarios, such that a second communication connection is established in an SA network in a 5G mobile communication system. These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

FIG. 1 is a schematic diagram of a communication system according to some embodiments of the present disclosure;

FIG. 2 is a schematic flowchart of a method for sending subscriber identifiers according to some embodiments of the present disclosure;

FIG. 3 is a schematic flowchart of another method for sending subscriber identifiers according to some embodiments of the present disclosure;

FIG. 4 is a schematic flowchart of still another method for sending subscriber identifiers according to some embodiments of the present disclosure;

FIG. 5 is a schematic diagram of an apparatus for sending subscriber identifiers according to some embodiments of the present disclosure; and

FIG. 6 is a schematic diagram of a device for sending subscriber identifiers according to some embodiments of the present disclosure.

### DETAILED DESCRIPTION

The technical solutions of the present disclosure are described in detail with reference to the accompanying drawings.

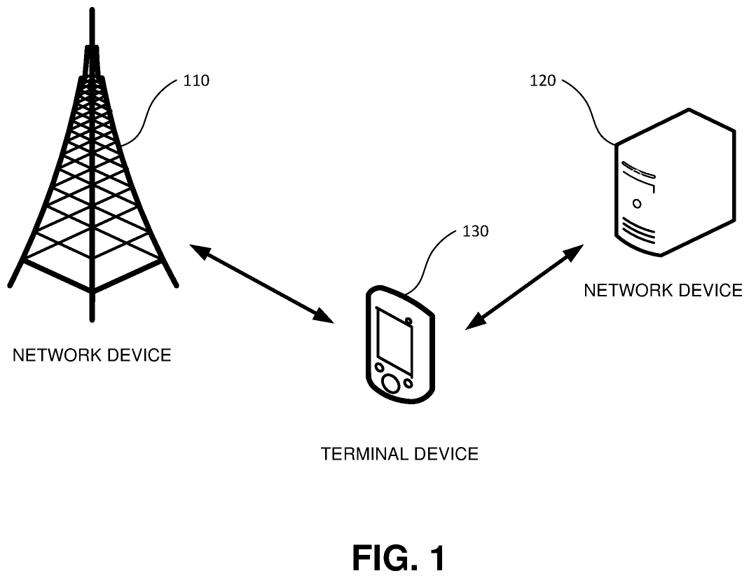

First, an application scenario of the present disclosure is introduced. FIG. 1 is a schematic diagram of a communication system 100 applicable to the present disclosure.

The communication system 100 includes a network device 110, a network device 120, and a terminal device 130.

In the present disclosure, the network device 110 may be a base station defined by 3GPP, for example, a gNodeB (gNB) defined in a 5G communication system. The network device 110 may also be a relay station, an access point, a vehicle-mounted device, a wearable device, or any other type of communication device.

The network device 120 may be a server, and is configured to provide information required for establishing a communication connection for the terminal device 130. For example, the server may include at least one UICC, and when the terminal device 130 needs to establish the communication connection with the network device 110, the server provides an authentication service needed for establishing the communication connection. Therefore, the network device 120 may also be referred to as a remote authentication module or a cloud card pool.

The terminal device 130 is capable of communicating with the network device 110 and the communication device 120. The terminal device 130 may include various handheld devices, vehicle-mounted devices, or wearable devices having a wireless communication function, for example, user equipments (UEs), mobile stations (MS s), mobile equipments (MEs), and the like defined in the 3rd Generation Partnership Project (3GPP).

The communication system 100 is only exemplarily illustrated. It should be noted that the communication system applicable to the present disclosure is not limited to the communication system 100 illustrated herein. For example, the communication system 100 may include more network devices.

For security of the network, when the terminal device 130 attempts to establish the communication connection with the network device 110, the network device 110 needs to verify the identity of the terminal device 130, When the communication connection is a communication connection of a standalone (SA) network in a fifth generation (5G) mobile communication system, the SA network needs to verify an identity of the terminal device during establishment of the communication connection. that is, the network device 110 needs to acquire the SUCI of the terminal device 130. The SUCI may be generated at the terminal device 130 or at the network device 120. The terminal device 130 may send the SUCI to the network device 110 upon acquiring the SUCI, such that the network device 110 establishes the communication connection upon security verification on the SUCI. Identity verification needs to be performed on the terminal device in the SA network for establishment of the communication connection in cloud communication scenarios.

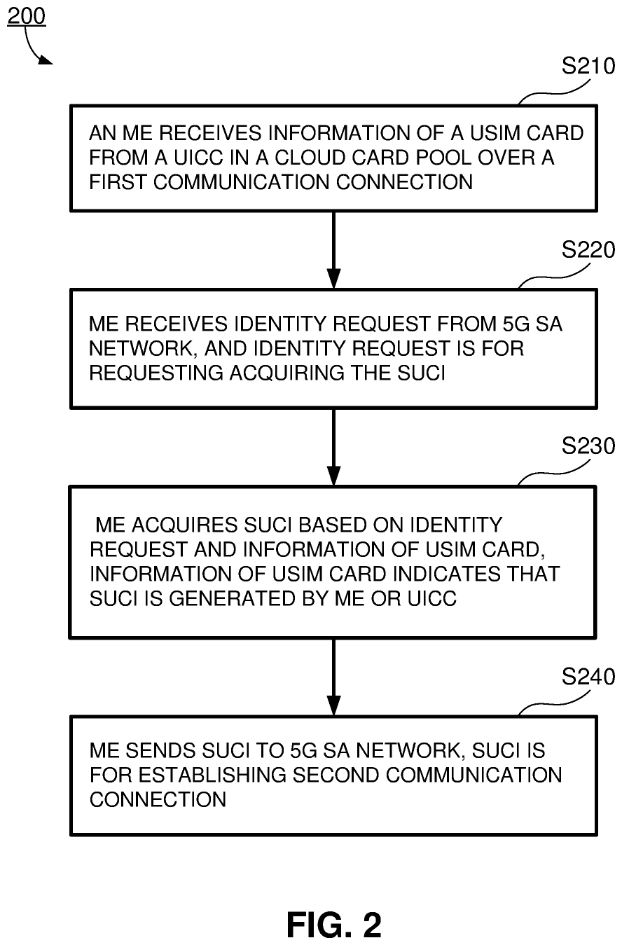

A method 200 for sending subscriber identifiers according to the present disclosure is described in detail hereinafter. As illustrated in FIG. 2, the method 200 includes the following steps.

At S210, an ME receives information of a USIM card from a UICC in a cloud card pool over a first communication connection.

The first communication connection may be a wireless connection, such as a cellular network connection or a Wi-Fi connection; or the first communication connection may also be a wired connection. The specific form of the first communication connection is not defined in the present disclosure.

In the present disclosure, words including “first,” “second,” and the like are used to distinguish different individuals in objects of the same type. For example, the first communication connection and a second communication connection hereinafter represent two different communication connections.

The information of the USIM card may be an EFust file (that is, a USIM service table) or other information, and the specific content of the information of the USIM card is not limited in the present disclosure.

The information of the USIM card is used for establishing the second communication connection. Upon acquiring the information of the USIM card, the ME may establish a radio resource control (RRC) link with a 5G SA network, and send a registration request including a globally unique temporary identifier (GUTI) to the 5G SA network over the RRC link. Upon receiving the registration request, the 5G SA network sends an identity request to the ME, and the ME may perform the following steps.

At S220, the ME receives the identity request from the 5G SA network, wherein the identity request is for requesting acquiring the SUCI.

At S230, the ME acquires the SUCI based on the identity request and the information of the USIM card, wherein the information of the USIM card indicates that the SUCI is generated by the ME or the UICC.

The SUCI may be generated at the ME or at the UICC. In some embodiments, where the information of the USIM card indicates that the SUCI needs to be generated at the ME, the ME may generate the SUCI locally, which avoids a delay of acquiring the SUCI from the UICC. In this way, the second communication connection may be quickly established. In some embodiments, where the information of the USIM card indicates that the SUCI needs to be generated at the UICC, for example, where the information of the USIM card does not include a service no 124 or a service no 125, the ME may acquire the SUCI from the UICC, thereby ensuring successful establishment of the second communication connection. For the definition of a service no 124 and a service no 125, reference may be made to 3GPP TS 31.102 version 15.1.0 Release paragraph 15 4.2.117.

Table 1 lists several cases of acquiring the SUCI.

TABLE 1

| | UICC | | ME | |
|---|---|---|---|---|
| Non- | N/A | | 1. | Client request |
| encrypt | | | 2. | Unauthenticated |
| scheme | | | | emergency sessions |
| | | | 3. | The inserted USIM is a |
| | | | | pre-Rel 15 card |
| | | | 4. | The inserted USIM is a |
| | | | | Rel 15 card, but the card |
| | | | | is configured for null- |
| | | | | scheme |
| Encrypt | 1. | Services no124 and | 1. | Services no124 and |
| scheme | | no125 should be available | | no125 are NOT available |
| | | in the EFust | | in the EFust |
| | 2. | The client requests with | 2. | The client requests with |
| | | concealment required as | | concealment required as |
| | | TRUE | | TRUE |

In Table 1, the client refers to an operator.

When the client configures information for executing non-encrypt scheme in the information of the USIM card, and when the information of the USIM card satisfies any one of the following four conditions in Table 1, the ME acquires the SUCI locally based on the identity request. When the client configures the information for executing the non-encrypt scheme in the information of USIM card and the information of the USIM card does not satisfy any one of the following four conditions (that is, the meaning indicated by “N/A” in Table 1), the ME acquires the SUCI from the UICC based on the identity request. The four conditions are as follows: the information of the USIM card includes configuration information of the SUCI requested by an operator and generated at the ME, the information of the USIM card includes configuration information of an unauthenticated emergency session, the information of the USIM card is information of a pre-Rel 15 card, and the information of the USIM card is information of a Rel 15 card but the Rel 15 card is configured to an unconcealed card.

When the client configures the information for executing non-encrypt scheme in the information of the USIM card, the ME may determine, according to whether the EFust file includes a service no 124 and a service no 125, the way of generating the SUCI. The encrypt scheme is, for example, an elliptic curve integrate encrypt scheme (ECIES). For example, when the EFust file does not include the service no 124 or the service no 125, the ME generates the SUCI locally; and when the EFust file includes the service no 124 and the service no 125, the ME acquires the SUCI from the UICC.

During acquiring the SUCI from the UICC based on the identity request, the ME may send the SUCI acquisition request to the UICC over the first communication connection and receive the SUCI from the UICC over the first communication connection.

Upon acquiring the SUCI, the ME may perform the following steps.

At S240, the ME sends the SUCI to the 5G SA network, wherein the SUCI is for establishing the second communication connection.

The first communication connection may be a roaming communication connection and the second communication connection may be a non-roaming communication connection. With the method 200, a non-roaming 5G communication connection is established in cloud communication scenarios, which reduces expenses for the subscribers.

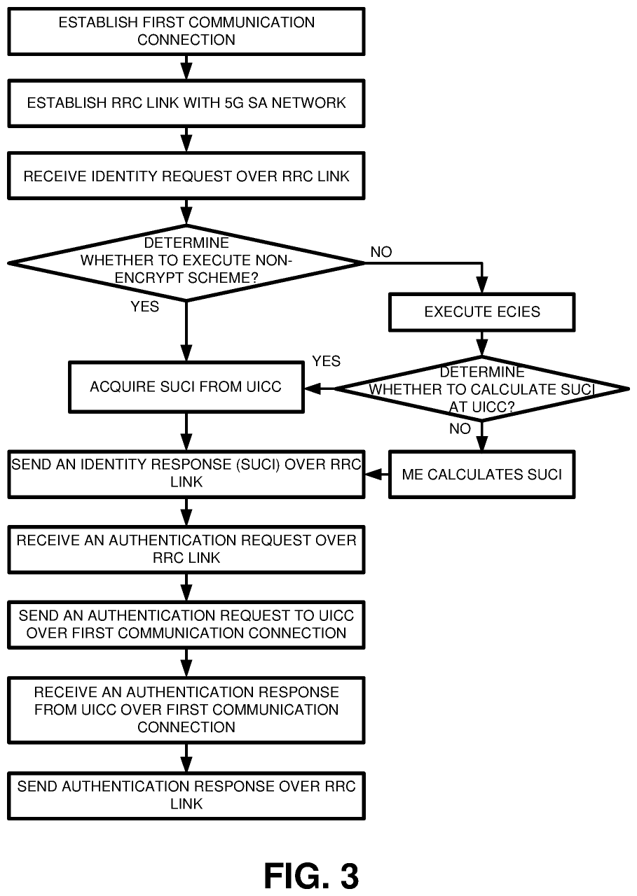

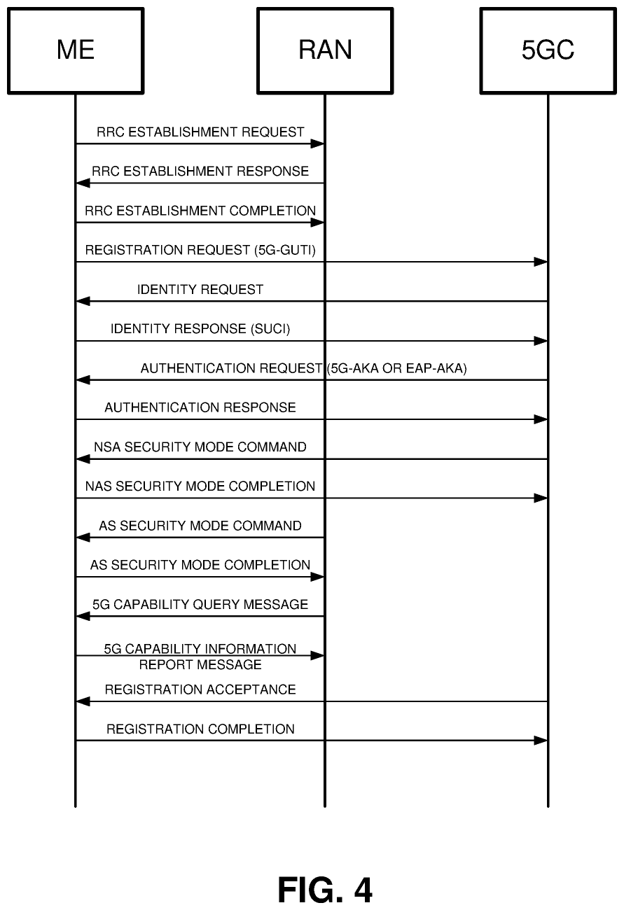

The procedure of establishing the second communication connection is further described hereinafter with reference to FIG. 3 and FIG. 4.

As illustrated in FIG. 3, upon establishing the first communication connection, the ME establishes the RRC link with the 5G SA network. Afterwards, the ME receives the identity request from the 5G SA network over the RRC link, and determines to acquire the SUCI based on the identity request.

The ME may determine, based on the information of the USIM card, whether or not to execute the non-encrypt scheme. In response to determining that the non-encrypt scheme is to be executed, the ME may acquire the SUCI from the UICC; and otherwise, the ME executes the ECIES, and determines, according to whether the EFust file includes the service no 124 and the service no 125, the way of generating the SUCI.

When the EFust file does not include the service no 124 or the service no 125, the ME generates the SUCI locally; and when the EFust file includes the service no 124 and the service no 125, the ME acquires the SUCI from the UICC.

Upon acquiring the SUCI, the ME may send an identity response including the SUCI to the 5G SA network over the RRC link, and then receive an authentication request from the 5G SA network over the RRC link. The ME may forward the authentication request to the UICC. Upon receiving an authentication response from the UICC, the ME forwards the authentication response to the 5G SA network over the RRC link to establish a communication connection (that is, the second communication connection) with the 5G SA network.

FIG. 4 is another schematic diagram for establishing the second communication connection.

The steps before the ME sends the authentication response to a 5G core (5GC) are the same as those in FIG. 3, which are not detailed herein. The authentication request may include 5G authentication and key agreement (AKA) information, and may also include extensible authentication protocol (EAP)-AKA information.

Upon completing authentication tasks, the 5GC may send a non-access stratum (NAS) security mode command to the ME over a wireless access network (RAN). Upon receiving the NAS security mode command, the ME executes the NAS security mode and sends a NAS security mode completion message to the 5GC over the RAN.

Afterwards, the RAN sends an access stratum (AS) security mode command to the ME. Upon receiving the AS security mode command, the ME executes the AS security mode, and sends AS security mode completion message to the RAN.

The RAN may also send a 5G capability query message to the ME. Upon receiving the 5G capability query message, the ME sends a 5G capability report message to the RAN.

Afterwards, the 5GC may send a registration acceptance message to the ME over the RAN, and receive a registration completion message from the ME over the RAN, such that the second communication connection is established.

Examples of sending subscriber identifiers according to the present disclosure are described in detail hereinabove. It may be understood that to implement the above functions, the apparatus for sending subscriber identifiers includes corresponding hardware structures and/or software modules for implementing the functions. A person skilled in the art could envisage that various exemplary units and algorithm steps described with reference to the embodiments of the present disclosure given herein may be practiced in the form of hardware or a combination of computer software and hardware. Whether a function is implemented in the form of hardware or computer software-driven hardware depends on the specific application and the design restrictions of the technical solution. Professional technical personnels may implement the described functions by using different methods for each specific application. However, such implementation shall not be deemed as going beyond the scope of the present disclosure.

In the present disclosure, the apparatus for sending subscriber identifiers may be divided into various functional units with reference to the above method embodiments. For example, various functions are assigned to various functional units for implementation of these functions, or two or more than two functions are integrated in one processing unit for implementation of these functions. The integrated units above may be implemented in a form of hardware or in a form of a software functional unit. It should be noted that definition of the functional units in the present disclosure is exemplary and illustrative, which is merely division in terms of logical functionality. In practice, the division of the apparatus may be achieved in any other form.

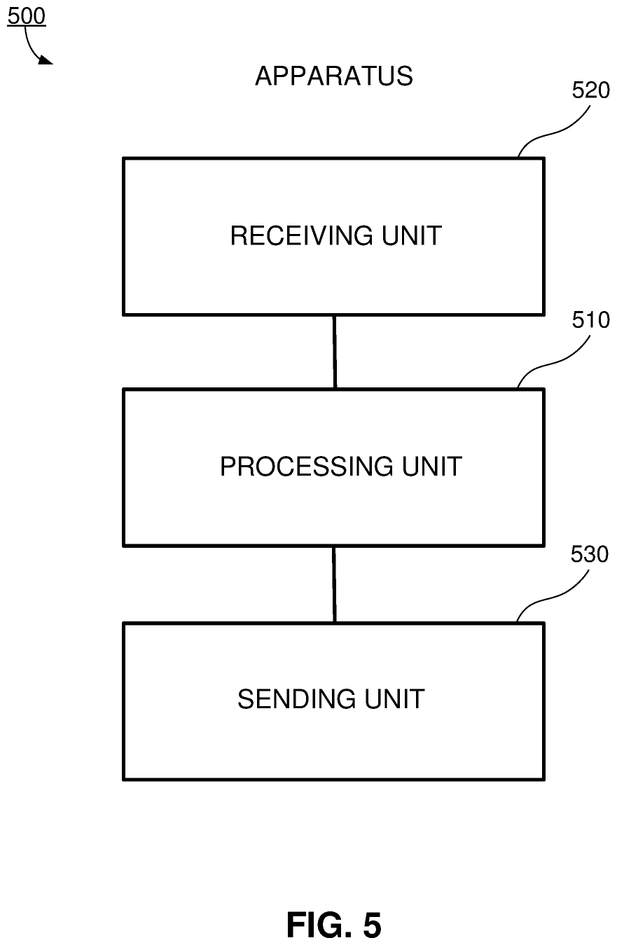

FIG. 5 is a schematic structural diagram of an apparatus 500 for sending subscriber identifiers according to the present disclosure. The apparatus 500 includes: a processing unit 510, a receiving unit 520, and a sending unit 530. The processing unit 510 implements a receiving function by means of the receiving unit 520. The processing unit 510 also implements a sending function by means of the sending unit 530.

The receiving unit 520 is configured to: receive information of a USIM card from a UICC in a cloud card pool over a first communication connection; and receive an identity request from a 5G SA network, wherein the identity request is for requesting acquiring a SUCI.

The processing unit 510 is configured to acquire the SUCI based on the identity request and the information of the USIM card, wherein the information of the USIM card indicates that the SUCI is generated by the apparatus 500 or the UICC.

The sending unit 530 is configured to send the SUCI to the 5G SA network, wherein the SUCI is for establishing a second communication connection.

In some embodiments, the processing unit 510 is specifically configured to: acquire the SUCI locally based on the identity request when the information of the USIM card includes concealment indication information and configuration information of the USIM card does not include a service no 124 or a service no 125; or acquire the SUCI from the UICC based on the identity request when the information of the USIM card includes concealment indication information and the configuration information of the USIM card includes the service no 124 and the service no 125.

In some embodiments, the processing unit 510 is specifically configured to: send a SUCI acquisition request to the UICC based on the identity request over the first communication connection; and acquire the SUCI from the UICC over the first communication connection.

In some embodiments, the processing unit 510 is specifically configured to: acquire the SUCI from the UICC based on the identity request when the information of the USIM card does not include concealment indication information and the information of the USIM card does not satisfy any one of the following four conditions; or acquire the SUCI locally based on the identity request when the information of the USIM card does not include concealment indication information and the information of the USIM card satisfies any one of the following four conditions.

The four conditions are as follows: the information of the USIM card includes configuration information of the SUCI requested by an operator and generated at the apparatus 500, the information of the USIM card includes configuration information of an unauthenticated emergency session, the information of the USIM card is information of a pre-Rel 15 card, and the information of the USIM card is information of a Rel 15 card but the Rel card is configured to an unconcealed card.

In some embodiments, the processing unit 510 is specifically configured to: send a SUCI acquisition request to the UICC based on the identity request over the first communication connection; and acquire the SUCI from the UICC over the first communication connection.

For details about practice of the method 200 by the apparatus 500 and the achieved beneficial effects, reference may be made to related descriptions in the above method embodiments.

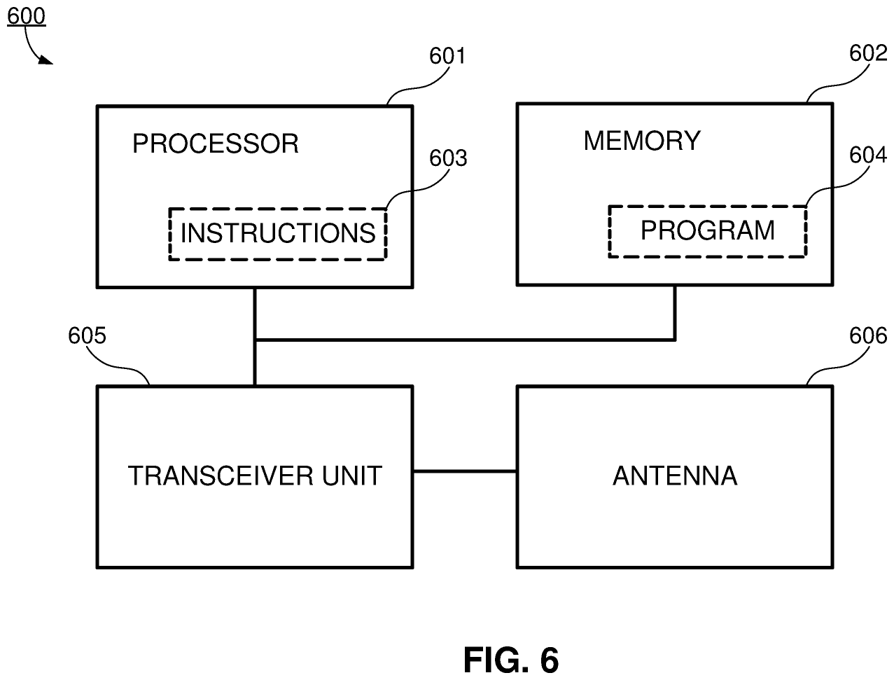

FIG. 6 is a schematic structural diagram of a device 600 for sending subscriber identifiers according to the present disclosure, wherein a dashed box indicates that the module or unit is optional. The device 600 may be employed to perform the method according to the above method embodiment, and the device 600 may be a chip or a terminal device.

The device 600 includes one or more processors 601. The one or more processors 601 support implementation, by the device 600, of the method according to the method embodiment as illustrated in FIG. 2. The processor 601 may be a general purpose processor or an application-specific processor. For example, the processor 601 is a central processing unit (CPU) or a baseband processor. The baseband processor may be configured to process communication data (for example, SUCI), and the CPU may be configured to control the device 600 to run a software program and process data of the software program.

The device 600 may further include a transceiver unit 605 and an antenna 606 to implement input (reception) and output (transmission) of signals.

In some embodiments, the device 600 may be a chip, the transceiver unit 605 may be an input and/or output circuit of the chip or a communication interface of the chip. The chip may serve as a component of the terminal device or any other wireless communication device.

The device 600 may include one or more memories 602 storing a program 604. The program 604 may be loaded and run by the processor 601 to generate one or more instructions 603, which, when loaded and executed by the processor 601, cause the processor 601 to perform the method according to the above method embodiment. Optionally, the memory 602 may also store data. Optionally, the processor 601 may also read the data stored in the memory 602. The data and the program 604 may be stored at the same storage address, or stored at different storage addresses.

The processor 601 and the memory 602 may be deployed independently or integrally. For example, the processor 601 and the memory 602 may be integrated on a system on chip (SoC).

It should be understood that various steps in the above method embodiments may be performed by means of a logic circuit in the form of hardware in the processor 601 or by means of instructions in the form of software. The processor 601 may be a central processing unit (CPU), a digital signal processor (DSP), an application specific integrated circuit (ASIC), a field-programmable gate array (FPGA), or any other programmable logic device, for example, a discrete gate or transistor logic device, or a discrete hardware component.

For details about practice of the method 200 by the device 600 and the achieved beneficial effects, reference may be made to related descriptions in the above method embodiments.

An embodiment of the present disclosure further provides a computer program product. The computer program product, when loaded and run by the processor 601, causes the processor 601 to perform the communication method according to any of the above method embodiments of the present disclosure.

The computer program product may be stored in the memory 620, for example, a program 604. The program 604 is eventually converted to a target file executable by the processor 601 by a series of processing including pre-processing, compilation, collection, and linking.

An embodiment of the present disclosure further provides a computer-readable storage medium, which stores a computer program. The computer program, when loaded and run by a computer, causes the computer to perform the communication method according to any of the above method embodiments of the present disclosure. The computer program may be an advanced language-programmed program or may be a runnable target program.

The computer-readable storage medium may be, for example, the memory 602. The memory 602 may be a volatile memory or a non-volatile memory, or the memory 602 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM), which serves as an external high-speed cache. Through example but not limitative description, many forms of RAMs may be used, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchlink dynamic random-access memory (SLDRAM), and a direct rambus dynamic random-access memory (DR RAM).

A person skilled in the art would clearly acknowledge that for ease and brevity of description, the specific operation processes of the above described systems, apparatuses and units may be referenced to the relevant portions in the above described method embodiments, which are thus not described herein any further.

In several embodiments of the present disclosure, it should be understood that the disclosed system, apparatus, and method may be implemented in other manners. For example, some features in the method embodiment may be ignored, or not executed. The above described apparatus embodiments are merely illustrative. For example, the unit division is merely logical function division and may be other divisions in actual practice. For example, multiple units or components may be combined or integrated into another system. In addition, coupling between the units or coupling between the components may be direct coupling or indirect coupling. The coupling includes electrical, mechanical, or other forms of connections.

It should be understood that in various embodiments of the present disclosure, the sequence numbers of the above various processes or steps do not denote a preferred sequence of performing the processes or steps; and the sequence of performing the processes and steps should be determined according to the functions and internal logics thereof, which shall not cause any limitation to the implementation process of the embodiments of the present disclosure.

In addition, the terms “system” and “network” in the specification are generally exchanged. The term “and/or” is merely an association relationship for describing associated objects, which represents that there may exist three types of relationships, for example, A and/or B may represent three situations: only A exists, both A and B exist, and only B exists. In addition, the symbol “/” generally represents an “or” relationship between associated objects before and after the symbol.

The above embodiments are merely exemplary embodiments of the technical solutions of the present disclosure, but are not intended to limit the protection scope of the present disclosure. Any modification, equivalent replacement, or improvement made without departing from the spirit and principle of the present disclosure should fall within the protection scope of the present disclosure.

What is claimed is:

1. A method for sending subscriber identifiers, comprising:
receiving, by a mobile equipment ME, information of a universal subscriber identity module USIM card from a universal integrated circuit card UICC in a cloud card pool over a first communication connection;
receiving, by the ME, an identity request from a 5G stand alone SA network, wherein the identity request is for requesting acquiring a subscriber concealed identifier SUCI;
acquiring, by the ME, the SUCI based on the identity request and the information of the USIM card, wherein the information of the USIM card indicates that the SUCI is generated by the ME or the UICC; and
sending, by the ME, the SUCI to the 5G SA network, wherein the SUCI is for establishing a second communication connection.

2. The method according to claim 1, wherein acquiring, by the ME, the SUCI based on the identity request and the information of the USIM card comprises:
acquiring, by the ME, the SUCI locally based on the identity request when the information of the USIM card comprises concealment indication information and configuration information of the USIM card does not comprise a service no 124 or a service no 125; or
acquiring, by the ME, the SUCI from the UICC based on the identity request when the information of the USIM card comprises concealment indication information and the configuration information of the USIM card comprises the service no 124 and the service no 125.

3. The method according to claim 2, wherein acquiring, by the ME, the SUCI from the UICC based on the identity request comprises:
sending, by the ME, a SUCI acquisition request to the UICC based on the identity request over the first communication connection; and
acquiring, by the ME, the SUCI from the UICC over the first communication connection.

4. The method according to claim 1, wherein acquiring, by the ME, the SUCI based on the identity request and the information of the USIM card comprises:
acquiring, by the ME, the SUCI from the UICC based on the identity request when the information of the USIM card does not comprise concealment indication information and the information of the USIM card does not satisfy any one of the following four conditions; or
acquiring, by the ME, the SUCI locally based on the identity request when the information of the USIM card does not comprise concealment indication information and the information of the USIM card satisfies any one of the following four conditions;
wherein the four conditions are as follows: the information of the USIM card comprises configuration information of the SUCI requested by an operator and generated at the ME, the information of the USIM card comprises configuration information of an unauthenticated emergency session, the information of the USIM card is information of a pre-Rel 15 card, and the information of the USIM card is information of a Rel 15 card but the Rel 15 card is configured to an unconcealed card.

5. The method according to claim 4, wherein acquiring, by the ME, the SUCI from the UICC based on the identity request comprises:
sending, by the ME, a SUCI acquisition request to the UICC based on the identity request over the first communication connection; and
acquiring, by the ME, the SUCI from the UICC over the first communication connection.

6. An apparatus for sending subscriber identifiers, comprising: a receiving unit, a processing unit, and a sending unit; wherein
the receiving unit is configured to receive information of a universal subscriber identity module USIM card from a universal integrated circuit card UICC in a cloud card pool over a first communication connection, and receive an identity request from a 5G stand alone SA network, wherein the identity request is for requesting acquiring a subscriber concealed identifier SUCI;
the processing unit is configured to acquire the SUCI based on the identity request and the information of the USIM card, wherein the information of the USIM card indicates that the SUCI is generated by the apparatus or the UICC; and
the sending unit is configured to send the SUCI to the 5G SA network, wherein the SUCI is for establishing a second communication connection.

7. The apparatus according to claim 6, wherein the processing unit is further configured to:
acquire the SUCI locally based on the identity request when the information of the USIM card comprises concealment indication information and configuration information of the USIM card does not comprise a service no 124 or a service no 125; or
acquire the SUCI from the UICC based on the identity request when the information of the USIM card comprises concealment indication information and the configuration information of the USIM card comprises the service no 124 and the service no 125.

8. The apparatus according to claim 7, wherein the processing unit is further configured to:
send a SUCI acquisition request to the UICC based on the identity request over the first communication connection; and
acquire the SUCI from the UICC over the first communication connection.

9. The apparatus according to claim 6, wherein the processing unit is further configured to:
acquire the SUCI from the UICC based on the identity request when the information of the USIM card does not comprise concealment indication information and the information of the USIM card does not satisfy any one of the following four conditions; or
acquire the SUCI locally based on the identity request when the information of the USIM card does not comprise concealment indication information and the information of the USIM card satisfies any one of the following four conditions;
wherein the four conditions are as follows: the information of the USIM card includes configuration information of the SUCI requested by an operator and generated at the apparatus, the information of the USIM card comprises configuration information of an unauthenticated emergency session, the information of the USIM card is information of a pre-Rel 15 card, and the information of the USIM card is information of a Rel 15 card but the Rel 15 card is configured to an unconcealed card.

10. The apparatus according to claim 9, wherein the processing unit is further configured to:
send a SUCI acquisition request to the UICC based on the identity request over the first communication connection; and
acquire the SUCI from the UICC over the first communication connection.
